(19) United States
(12) Patent Application Publication
(10) Pub. No.: US 2025/0294008 A1
(43) Pub. Date: Sep. 18, 2025

(54) DATA REQUEST METHOD AND APPARATUS, ELECTRONIC DEVICE, AND STORAGE MEDIUM

(71) Applicant: Beijing Zitiao Network Technology Co., Ltd., Beijing (CN)

(72) Inventors: Lei MA, Beijing (CN); Yifan YANG, Beijing (CN); Wenfeng SUN, Beijing (CN); Yingrui LI, Beijing (CN)

(21) Appl. No.: 19/079,126

(22) Filed: Mar. 13, 2025

(30) Foreign Application Priority Data
Mar. 13, 2024 (CN) 202410288599.7

(51) Int. Cl. H04L 61/4511; H04L 61/10; H04L 61/5007

(52) U.S. Cl. CPC H04L 61/4511; H04L 61/10; H04L 61/5007

(57) ABSTRACT

Embodiments of the present disclosure disclose a data request method and apparatus, an electronic device, and a storage medium. The method is applied to a client and includes: sending a data request to a business server, so that the business server determines, based on the data request, address description information of data to be requested; receiving a first internet protocol address sent by the business server, where the first internet protocol address is obtained by performing network-side domain name resolution on the address description information by the business server; and requesting, based on the first internet protocol address, data content of the data to be requested.

### CROSS-REFERENCE TO RELATED APPLICATION

This application claims the priority to and benefits of the Chinese Patent Application, No. CN202410288599.7, which was filed on Mar. 13, 2024. The aforementioned patent application is hereby incorporated by reference in its entirety.

### TECHNICAL FIELD

Embodiments of the present disclosure relate to the field of computer technologies, and in particular, to a data request method and apparatus, an electronic device, and a storage medium.

### BACKGROUND

When a client requests data, domain name resolution of the client is usually performed by a local domain name system (DNS) through a network of an operator. Such a resolution method not only has a risk of a resolution result being hijacked by the operator, but also has problems of a long resolution time and a low success rate.

### SUMMARY

Embodiments of the present disclosure provide a data request method and apparatus, an electronic device, and a storage medium, which can avoid a risk of a resolution result being hijacked and solve problems of a long resolution time and a low success rate.

According to a first aspect, an embodiment of the present disclosure provides a data request method. The method is applied to a client and includes: sending a data request to a business server, so that the business server determines, based on the data request, address description information of data to be requested; receiving a first internet protocol address sent by the business server, where the first internet protocol address is obtained by performing a network-side domain name resolution on the address description information by the business server; and requesting, based on the first internet protocol address, data content of the data to be requested.

According to a second aspect, an embodiment of the present disclosure provides a data request method. The method is applied to a server and includes: receiving a data request sent by a client, and determining, based on the data request, address description information of data to be requested; performing a network-side domain name resolution on the address description information to obtain a first internet protocol address; and sending the first internet protocol address to the client, so that the client requests, based on the first internet protocol address, data content of the data to be requested.

According to a third aspect, an embodiment of the present disclosure provides a data request apparatus. The apparatus is applied to a client and includes: a first sending module configured to send a data request to a business server, so that the business server determines, based on the data request, address description information of data to be requested; a first receiving module configured to receive a first internet protocol address sent by the business server, where the first internet protocol address is obtained by performing a network-side domain name resolution on the address description information by the business server; and a content request module configured to request, based on the first internet protocol address, data content of the data to be requested.

According to a fourth aspect, an embodiment of the present disclosure provides a data request apparatus. The apparatus is applied to a server and includes: a second receiving module configured to receive a data request sent by a client, and determine, based on the data request, address description information of data to be requested; a domain name resolution module configured to perform a network-side domain name resolution on the address description information to obtain a first internet protocol address; and a second sending module configured to send the first internet protocol address to the client, so that the client requests, based on the first internet protocol address, data content of the data to be requested.

According to a fifth aspect, an embodiment of the present disclosure provides an electronic device. The electronic device includes: one or more processors; and a storage apparatus configured to store one or more programs, where the one or more programs, when executed by the one or more processors, cause the one or more processors to implement the data request method described in any one of the embodiments of the present disclosure.

According to a sixth aspect, an embodiment of the present disclosure provides a storage medium including computer-executable instructions that, when executed by a computer processor, cause the computer processor to perform the data request method described in any one of the embodiments of the present disclosure.

The technical solutions of the embodiments of the present disclosure are applied to the data request method of the client. The data request may be sent to the business server, so that the business server determines, based on the data request, the address description information of the data to be requested; the first internet protocol address sent by the business server is received, where the first internet protocol address is obtained by performing the network-side domain name resolution on the address description information by the business server; and the data content of the data to be requested is requested based on the first internet protocol address. By performing the domain name resolution task by the server, the resolution result can be prevented from being hijacked, and the problems of a long domain name resolution time and a low success rate can be solved.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of a data request method according to an embodiment of the present disclosure;

FIG. 2 is a schematic diagram of signaling interaction of a data request method according to an embodiment of the present disclosure;

FIG. 3 is a schematic flowchart of a data request method according to an embodiment of the present disclosure;

FIG. 4 is a schematic flowchart of a data request method according to an embodiment of the present disclosure;

FIG. 5 is a schematic diagram of a structure of a data request apparatus according to an embodiment of the present disclosure;

FIG. 6 is a schematic diagram of a structure of a data request apparatus according to an embodiment of the present disclosure; and

FIG. 7 is a schematic diagram of a structure of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

FIG. 1 is a schematic flowchart of a data request method according to an embodiment of the present disclosure. This embodiment of the present disclosure is applicable to a case in which a client requests data from a server. The method may be performed by a data request apparatus. The apparatus may be implemented in the form of software and/or hardware, and may be configured in an electronic device, for example, in a mobile phone or a computer.

As shown in FIG. 1, the data request method provided in this embodiment is applied to a client, and may include the steps as follows.

S110: Send a data request to a business server, so that the business server determines, based on the data request, address description information of data to be requested.

In this embodiment of the present disclosure, the client may send a data request for business data to the business server, and the business data is the data to be requested. For different businesses, the data to be requested may be different. For example, the data to be requested may be feed stream data.

In the client, a data request may be sent in response to a preset operation. For example, a data request may be sent in response to triggering a data request control, or in response to a preset gesture (for example, a swipe-up or a drop-down), etc., which are not exhausted herein.

S120: Receive a first internet protocol address sent by the business server, where the first internet protocol address is obtained by performing a network-side domain name resolution on the address description information by the business server.

In this embodiment of the present disclosure, the business server may determine, based on the data request, the description information of the data to be requested. The description information may be structural information, and the description information may include the address description information of the data to be requested, and may further include other information items depending on different businesses. For example, when the data to be requested is feed stream data, the description information may further include author description information and publication time description information. The address description information may include information such as a domain name.

After the business server obtains the address description information, the business server may perform network-side domain name resolution depending on its powerful resources and performance, to resolve the address description information into the first internet protocol (IP) address. The network-side domain name resolution may include, for example: determining, based on a mapping relationship table cached in at least one DNS on a network side, the first internet protocol address corresponding to the address description information. Afterwards, the business server may return, to the client, the first internet protocol address together with the description information of the data to be requested, and the description information returned in this case may include the address description information, or may not include the address description information. Correspondingly, the client may receive the first internet protocol address.

S130: Request, based on the first internet protocol address, data content of the data to be requested.

In this embodiment of the present disclosure, the client may skip the stage of domain name resolution and directly request the data content base on the first internet protocol address returned by the business server, and after the data content is obtained, the data content may be rendered on a real interface. A domain name resolution task in a data request process is moved to the server for execution, so that the client can obtain a domain name resolution result faster, and optimize a data request path, to avoid a risk of the domain name resolution result being hijacked, enable the data to be requested to be displayed on the client faster, and improve a success rate of data obtaining.

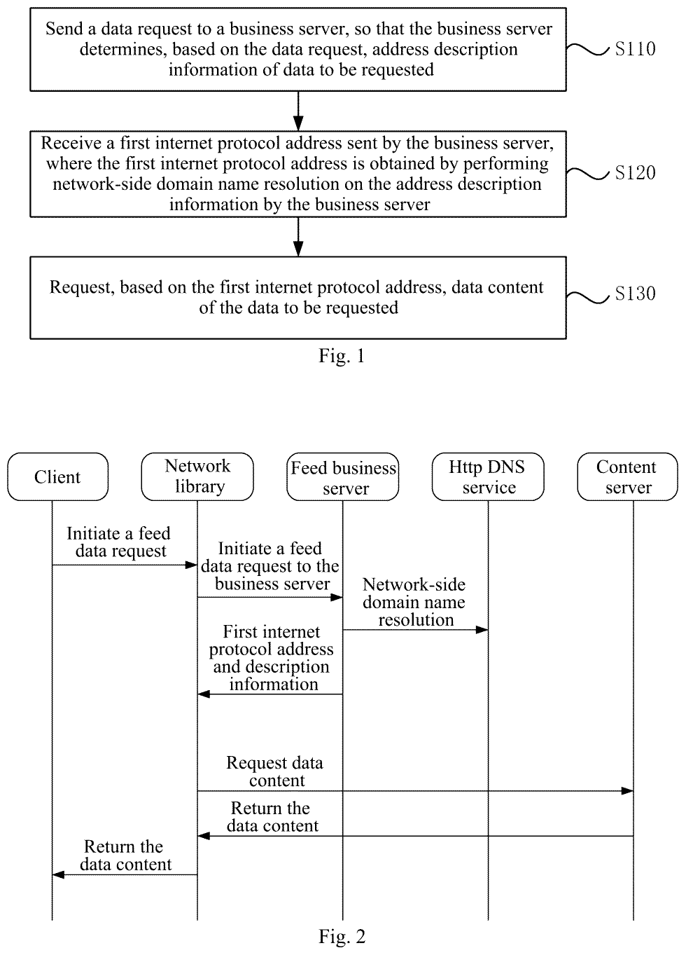

For example, FIG. 2 is a schematic diagram of signaling interaction of a data request method according to an embodiment of the present disclosure. Referring to FIG. 2, a process of the client obtaining feed data is described by using an example in which the data to be requested is the feed data.

First, the client can initiate a feed data request to a feed business server through a network library. Next, the feed business server may obtain description information of the feed data from a recommendation server, and may perform a network-side domain name resolution using an Http DNS service based on first feed item data in the description information, to obtain the first internet protocol address. Afterwards, the business server may return, to the client, the first internet protocol address together with the description information of the feed data. Finally, the client may establish a connection to the content server through TCP connection establishment, SSL handshakes, and other operations based on the first internet protocol address, and finally obtain the data content of the feed data from the content server.

According to the technical solutions of the embodiments of the present disclosure, the data request may be sent to the business server, so that the business server determines, based on the data request, the address description information of the data to be requested; the first internet protocol address sent by the business server is received, where the first internet protocol address is obtained by performing the network-side domain name resolution on the address description information by the business server; and the data content of the data to be requested is requested based on the first internet protocol address. A domain name resolution task is performed on the server, so that a DNS can be prevented from being hijacked, and the problems of a long domain name resolution time and a low success rate can be solved.

This embodiment of the present disclosure may be combined with various optional solutions in the data request method provided in the above embodiments. According to the data request method provided in this embodiment, the process of requesting the data content is optimized. For an electronic device whose local performance is higher than the preset performance, in addition to using the first internet protocol address to establish a connection to the content server during the process of requesting the data content, the client installed thereon can further resolve local address description information in real time and establish a connection to the content server based on a resolution status. Furthermore, data content can be obtained based on a faster line of the two connection establishment lines, that is, an optimal connection establishment line can be selected through racing between the two connection establishment lines. The performance being higher than the preset performance may include at least one of the following: the network speed being higher than a preset network speed, memory resources being greater than a preset memory, and computing power resources being greater than a preset computing power and etc.

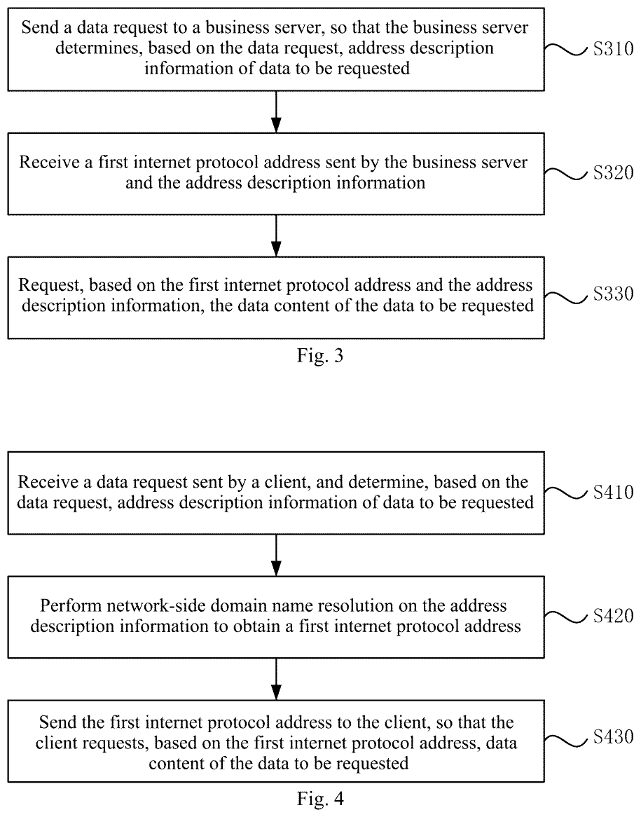

FIG. 3 is a schematic flowchart of a data request method according to an embodiment of the present disclosure. As shown in FIG. 3, the data request method provided in this embodiment may include steps as follows.

S310: Send a data request to a business server, so that the business server determines, based on the data request, address description information of data to be requested.

S320: Receive a first internet protocol address sent by the business server and the address description information.

In this embodiment, the first internet protocol address is obtained by performing the network-side domain name resolution on the address description information by the business server. In addition to feeding back the first internet protocol address to a client, the business server may further feedback description information including the address description information to the client. Correspondingly, the client may receive the first internet protocol address and the address description information.

S330: Request, based on the first internet protocol address and the address description information, the data content of the data to be requested.

Because the first internet protocol address is obtained by resolving a cached mapping relationship table, the first internet protocol address may not be updated in time to a specific extent. Therefore, quality of the first internet protocol address may be affected to a certain extent. In this embodiment, data content may be requested based on the first internet protocol address. Alternatively, real-time local domain name resolution may be performed on the address description information, and data content may be requested based on a resolution result, thereby ensuring smooth request of data content when the first internet protocol address is wrong.

In some optional implementations, the requesting, based on the first internet protocol address and the address description information, the data content of the data to be requested may include: establishing a first connection to a content server based on the first internet protocol address, and performing local domain name resolution on the address description information; and requesting, from the content server based on an establishment status of the first connection and a resolution status of the local domain name resolution, the data content of the data to be requested.

The establishing a first connection to a content server based on the first internet protocol address may be considered as establishing a transmission control protocol (TCP) connection to the content server based on the first internet protocol address. The client may perform real-time local domain name resolution based on the address description information through existing methods, and then establish a TCP connection to the content server based on the resolution status.

The process of establishing the first connection and the process of local domain name resolution may be performed simultaneously to achieve fair racing between the two connection establishment methods. By obtaining the data content based on a faster line of the two connection establishment lines, the efficiency and success rate of data requests can be optimized.

For example, the data content of the data to be requested is requested from the content server based on the establishment status of the first connection and the resolution status of the local domain name resolution, as shown in Table 1.

TABLE 1

| Possible establishment status and resolution status | Corresponding processing |
|---|---|
| Successful establishment, resolving | The first connection is used to request data content |
| | from the content server and the local domain name |
| | resolution process is canceled |
| Establishing, failed resolution | The first connection continues to be established |
| Establishing, successful resolution | A second internet protocol address obtained by |
| | resolution is compared with the first internet protocol |
| | address, and the data content is requested based on a |
| | comparison result |
| Failed establishment, resolving | The local domain name resolution continues to be |
| | performed |

Referring to Table 1, when the establishment status is successful establishment and the resolution status is resolving, the first internet protocol address may be considered right. In this case, the data content may be quickly requested from the content server based on the first connection, and the local domain name resolution process may be canceled.

When the establishment status is establishing and the resolution status is failed resolution, it may be considered that local performance is currently poor, and in this case, the first connection may continue to be established.

When the establishment status is establishing and the resolution status is successful resolution, the first internet protocol address may be right or wrong. In this case, the second internet protocol address obtained by resolution is compared with the first internet protocol address, and the data content is requested from the content server based on a comparison result. The data content being requested from the content server based on the comparison result may include the following steps: when the second internet protocol address is the same as the first internet protocol address, the first internet protocol address may be considered right, and in this case, the first connection may continue to be established; and when the second internet protocol address is different from the first internet protocol address, the first internet protocol address may be considered wrong, and in this case, a second connection may be established to the content server based on the second internet protocol address, and the first connection establishment process may be canceled.

When the establishment status is failed establishment and the resolution status is resolving, the first internet protocol address may be considered wrong, and in this case, the local domain name resolution may continue to be performed. After the second internet protocol address is obtained by resolution, the second connection may be established to the content server based on the second internet protocol address.

In these optional implementations, various possible cases of the establishment status of the first connection and the resolution status of the local domain name resolution may be handled separately to achieve fast TCP connection establishment. Then, the client may establish a connection to the content server through SSL handshakes and other operations, and may finally obtain the data content from the content server.

In some optional implementations, the requesting, based on the first internet protocol address and the address description information, the data content of the data to be requested may further include: stablishing a first connection to a content server based on the first internet protocol address; if the first connection is not established within a preset time, performing local domain name resolution on the address description information; and requesting, from the content server based on an establishment status of the first connection and a resolution status of the local domain name resolution, the data content of the data to be requested.

The preset time may be preset according to actual situations, for example, 1 second or 2 seconds. In these optional implementations, because performing the first connection and the local domain name resolution at the same time requires large resource overheads, an unfair racing strategy may be used when resources are limited. That is, the first connection may be first established to the content server based on the first internet protocol address. If the connection is not established successfully within the preset time duration, the local domain name resolution and connection establishment may be started, and racing between the two connection establishment lines is performed. For the racing process of the two connection establishment lines, reference may be made to the foregoing description.

According to the technical solutions of this embodiment of the present disclosure, the process of requesting the data content is optimized. For an electronic device whose local performance is higher than the preset performance, in addition to using the first internet protocol address to establish a connection to the content server during the process of requesting the data content, the client installed thereon can further resolve local address description information in real time and establish a connection to the content server based on a resolution status. Furthermore, data content can be obtained based on a faster line of the two connection establishment lines, that is, an optimal connection establishment line can be selected through racing between the two connection establishment lines.

Furthermore, the data request method provided in this embodiment of the present disclosure and the data request method provided in the above embodiments belong to the same concept of disclosure. For the technical details not described in detail in this embodiment, reference may be made to the above embodiments, and the same technical features have the same beneficial effects in this embodiment and the above embodiments.

FIG. 4 is a schematic flowchart of a data request method according to an embodiment of the present disclosure. This embodiment of the present disclosure is applicable to a case in which a client requests data from a server. The method may be performed by a data request apparatus. The apparatus may be implemented in the form of software and/or hardware, and may be configured in an electronic device, for example, in a server.

As shown in FIG. 4, the data request method provided in this embodiment is applied to the server, and may include the steps as follows.

S410: Receive a data request sent by a client, and determine, based on the data request, address description information of data to be requested.

S420: Perform network-side domain name resolution on the address description information to obtain a first internet protocol address.

S430: Send the first internet protocol address to the client, so that the client requests, based on the first internet protocol address, data content of the data to be requested.

In some optional implementations, the data request method may further include: sending the address description information to the client, so that the client requests, based on the first internet protocol address and the address description information, the data content of the data to be requested.

In these optional implementations, the address description information is sent to the client, so that the client can make fair or unfair racing between establishing a connection to the content server based on the first internet protocol address and establishing a connection based on a local real-time resolution DNS, so as to select an optimal connection establishment line, which is beneficial to improving the efficiency and success rate of data requests.

According to the technical solutions of this embodiment of the present disclosure, the data request sent by the client is received, and the address description information of the data to be requested is determined based on the data request; the network-side domain name resolution is performed on the address description information to obtain the first internet protocol address; and the first internet protocol address is sent to the client, so that the client requests, based on the first internet protocol address, the data content of the data to be requested. A domain name resolution task is performed by the server, so that a DNS can be prevented from being hijacked, and the problems of a long domain name resolution time and a low success rate can be solved. Furthermore, the data request method provided in this embodiment of the present disclosure and the data request method provided in the above embodiments and applied to the client belong to the same concept of disclosure. For the technical details not described in detail in this embodiment, reference may be made to the above embodiments, and the same technical features have the same beneficial effects in this embodiment and the above embodiments.

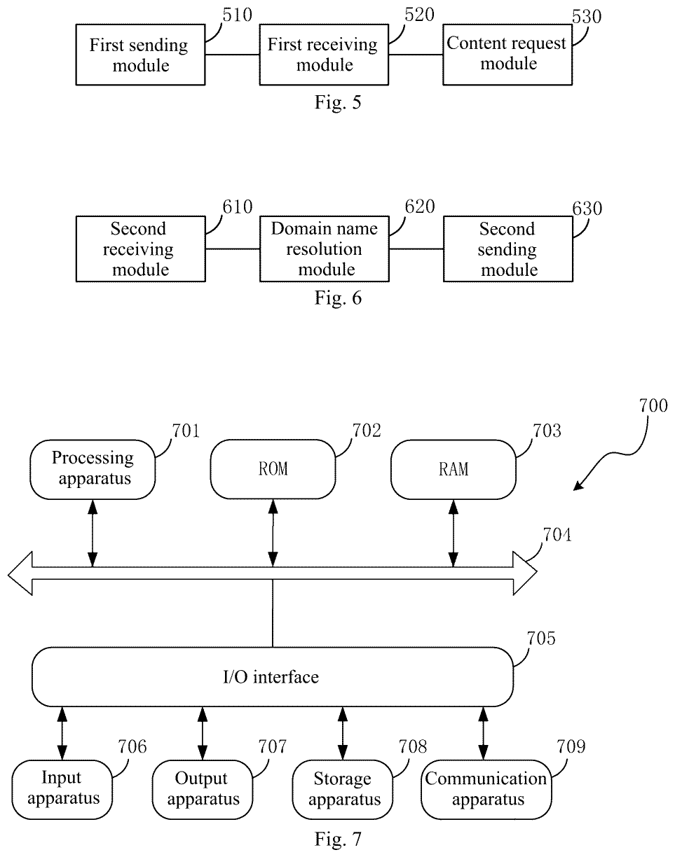

FIG. 5 is a schematic diagram of a structure of a data request apparatus according to an embodiment of the present disclosure. The data request apparatus provided in this embodiment is applicable to a case in which a client requests data from a server.

As shown in FIG. 5, the data request apparatus provided in this embodiment of the present disclosure is applied to the client, and may include: a first sending module 510, a first receiving module 520 and a content request module 530.

The first sending module 510 is configured to send a data request to a business server, so that the business server determines, based on the data request, address description information of data to be requested.

The first receiving module 520 is configured to receive a first internet protocol address sent by the business server, where the first internet protocol address is obtained by performing network-side domain name resolution on the address description information by the business server.

The content request module 530 is configured to request, based on the first internet protocol address, data content of the data to be requested.

In some optional implementations, the first receiving module may be further configured to receive the address description information sent by the business server. Correspondingly, the content request module may be configured to request, based on the first internet protocol address and the address description information, the data content of the data to be requested.

In some optional implementations, the content request module may be configured to: establish a first connection to a content server based on the first internet protocol address, and perform local domain name resolution on the address description information; and request, from the content server based on an establishment status of the first connection and a resolution status of the local domain name resolution, the data content of the data to be requested.

In some optional implementations, the content request module may be configured to: when the establishment status is successful establishment and the resolution status is resolving, request the data content from the content server based on the first connection; when the establishment status is establishing and the resolution status is failed resolution, continue to establish the first connection; when the establishment status is establishing and the resolution status is successful resolution, compare a second internet protocol address obtained by resolution with the first internet protocol address, and request the data content from the content server based on a comparison result; and when the establishment status is failed establishment and the resolution status is resolving, continue to perform the local domain name resolution.

In some optional implementations, the content request module may be configured to: when the second internet protocol address is the same as the first internet protocol address, continue to establish the first connection; and when the second internet protocol address is different from the first internet protocol address, establish a second connection to the content server based on the second internet protocol.

In some optional implementations, the content request module may be configured to: establish a first connection to a content server based on the first internet protocol address; if the first connection is not established within a preset time duration, perform local domain name resolution on the address description information; and request, from the content server based on an establishment status of the first connection and a resolution status of the local domain name resolution, the data content of the data to be requested.

The data request apparatus according to this embodiment of the present disclosure can perform the data request method according to any one of the embodiments of the present disclosure and applied to the client, and has corresponding functional modules and beneficial effects for performing the method.

It is worth noting that the units and modules included in the above apparatus are named according to the functional logic, but are not limited to those specific units and modules, as long as corresponding functions can be implemented. In addition, specific names of the functional units are merely used for distinguishing from each other, and are not used to limit the protection scope of the embodiments of the present disclosure.

FIG. 6 is a schematic diagram of a structure of a data request apparatus according to an embodiment of the present disclosure. The data request apparatus provided in this embodiment is applicable to a case in which a client requests data from a server.

As shown in FIG. 6, the data request apparatus provided in this embodiment of the present disclosure is applied to the server, and may include: a second receiving module 610, a domain name resolution module 620 and a second sending module 630.

The second receiving module 610 is configured to receive a data request sent by a client, and determine, based on the data request, address description information of data to be requested.

The domain name resolution module 620 is configured to perform network-side domain name resolution on the address description information to obtain a first internet protocol address.

The second sending module 630 is configured to send the first internet protocol address to the client, so that the client requests, based on the first internet protocol address, data content of the data to be requested.

In some optional implementations, the second sending module may be further configured to: send the address description information to the client, so that the client requests, based on the first internet protocol address and the address description information, the data content of the data to be requested.

The data request apparatus according to this embodiment of the present disclosure can perform the data request method according to any one of the embodiments of the present disclosure and applied to the server, and has corresponding functional modules and beneficial effects for performing the method.

It is worth noting that the units and modules included in the above apparatus are named according to the functional logic, but are not limited to the specific units and modules, as long as corresponding functions can be implemented. In addition, specific names of the functional units are merely used for distinguishing from each other, and are not used to limit the protection scope of the embodiments of the present disclosure.

Reference is made to FIG. 7 below, which is a schematic diagram of a structure of an electronic device 700 (such as a terminal device or a server in FIG. 7) suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 7 is merely an example, and shall not impose any limitation on the function and scope of use of the embodiments of the present disclosure.

As shown in FIG. 7, the electronic device 700 may include a processing apparatus 701 (e.g., a central processing unit, a graphics processing unit, etc.) that may perform a variety of appropriate actions and processing in accordance with a program stored in a read-only memory (ROM) 702 or a program loaded from a storage apparatus 708 into a random-access memory (RAM) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatuses may be connected to the I/O interface 705: an input apparatus 706 including, for example, a touchscreen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a tape and a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or arrange all of the shown apparatuses. It may be an alternative to implement or arrange more or fewer apparatuses.

According to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 709, or installed from the storage apparatus 708, or installed from the ROM 702. When the computer program is executed by the processing apparatus 701, the above functions defined in the data request method of the embodiment of the present disclosure are performed.

The electronic device provided in this embodiment of the present disclosure and the data request methods provided in the above embodiments belong to the same concept of disclosure. For the technical details not described in detail in this embodiment, reference may be made to the above embodiments, and this embodiment and the above embodiments have the same beneficial effects.

An embodiment of the present disclosure provides a computer storage medium storing a computer program thereon, where the program, when executed by a processor, implements the data request method according to the above embodiments.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electric connection with one or more wires, a portable computer disk, a hard disk, a random access memory (RAM), a read only memory (ROM), an erasable programmable read-only memory (EPROM) or a flash memory (FLASH), an optical fiber, a portable compact disc read only memory (CD-ROM), an optical storage device, a magnetic storage device, or any appropriate combination of the above. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server may communicate using any currently known or future-developed network protocol such as a Hypertext Transfer Protocol (HTTP), and may be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: send a data request to a business server, so that the business server determines, based on the data request, address description information of data to be requested; receive a first internet protocol address sent by the business server, where the first internet protocol address is obtained by performing network-side domain name resolution on the address description information by the business server; and request, based on the first internet protocol address, data content of the data to be requested.

In another example, the above computer-readable medium carries one or more programs. The one or more programs, when executed by the electronic device, cause the electronic device to: receive a data request sent by a client, and determine, based on the data request, address description information of data to be requested; perform network-side domain name resolution on the address description information to obtain a first internet protocol address; and send the first internet protocol address to the client, so that the client requests, based on the first internet protocol address, data content of the data to be requested.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The names of the units and the modules do not constitute a limitation on the units and the modules themselves under certain circumstances.

The functions described herein above may be performed at least partially by one or more hardware logic components. For example, without limitation, exemplary types of hardware logic components that may be used include: a field programmable gate array (FPGA), an application specific integrated circuit (ASIC), application specific standard parts (ASSPs), a system on chip (SOC), a complex programmable logic device (CPLD), etc.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, a data request method is provided, which is applied to a client, and the method includes: sending a data request to a business server, so that the business server determines, based on the data request, address description information of data to be requested; receiving a first internet protocol address sent by the business server, where the first internet protocol address is obtained by performing network-side domain name resolution on the address description information by the business server; and requesting, based on the first internet protocol address, data content of the data to be requested.

According to one or more embodiments of the present disclosure, the data request method is provided, further including: in some optional implementations, receiving the address description information sent by the business server; and correspondingly, the requesting includes: requesting, based on the first internet protocol address and the address description information, the data content of the data to be requested.

According to one or more embodiments of the present disclosure, the data request method is provided, wherein, in some optional implementations, the requesting, based on the first internet protocol address and the address description information, the data content of the data to be requested includes: establishing a first connection to a content server based on the first internet protocol address, and performing local domain name resolution on the address description information; and requesting, from the content server based on an establishment status of the first connection and a resolution status of the local domain name resolution, the data content of the data to be requested.

According to one or more embodiments of the present disclosure, the data request method is provided, wherein, in some optional implementations, the requesting, from the content server based on an establishment status of the first connection and a resolution status of the local domain name resolution, the data content of the data to be requested includes: when the establishment status is successful establishment and the resolution status is resolving, requesting the data content from the content server based on the first connection; when the establishment status is establishing and the resolution status is failed resolution, continuing to establish the first connection; when the establishment status is establishing and the resolution status is successful resolution, comparing a second internet protocol address obtained by resolution with the first internet protocol address, and requesting the data content from the content server based on a comparison result; and when the establishment status is failed establishment and the resolution status is resolving, continuing to perform the local domain name resolution.

According to one or more embodiments of the present disclosure, the data request method is provided, wherein, in some optional implementations, the requesting the data content from the content server based on a comparison result includes: when the second internet protocol address is the same as the first internet protocol address, continuing to establish the first connection; and when the second internet protocol address is different from the first internet protocol address, establishing a second connection to the content server based on the second internet protocol.

According to one or more embodiments of the present disclosure, the data request method is provided, wherein, in some optional implementations, the requesting, based on the first internet protocol address and the address description information, the data content of the data to be requested includes: establishing a first connection to a content server based on the first internet protocol address; if the first connection is not established within a preset time, performing local domain name resolution on the address description information; and requesting, from the content server based on an establishment status of the first connection and a resolution status of the local domain name resolution, the data content of the data to be requested.

According to one or more embodiments of the present disclosure, a data request method is provided, which is applied to a server, and the method includes: receiving a data request sent by a client, and determining, based on the data request, address description information of data to be requested; performing network-side domain name resolution on the address description information to obtain a first internet protocol address; and sending the first internet protocol address to the client, so that the client requests, based on the first internet protocol address, data content of the data to be requested.

According to one or more embodiments of the present disclosure, a data request apparatus is provided, which is applied to a client, and the apparatus includes: a first sending module configured to send a data request to a business server, so that the business server determines, based on the data request, address description information of data to be requested; a first receiving module configured to receive a first internet protocol address sent by the business server, where the first internet protocol address is obtained by performing network-side domain name resolution on the address description information by the business server; and a content request module configured to request, based on the first internet protocol address, data content of the data to be requested.

According to one or more embodiments of the present disclosure, a data request apparatus is provided, which is applied to a server, and the apparatus includes: a second receiving module configured to receive a data request sent by a client, and determine, based on the data request, address description information of data to be requested; a domain name resolution module configured to perform network-side domain name resolution on the address description information to obtain a first internet protocol address; and a second sending module configured to send the first internet protocol address to the client, so that the client requests, based on the first internet protocol address, data content of the data to be requested.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A data request method, applied to a client, comprising:
sending a data request to a business server, so that the business server determines, based on the data request, address description information of data to be requested;
receiving a first internet protocol address sent by the business server, wherein the first internet protocol address is obtained by performing network-side domain name resolution on the address description information by the business server; and
requesting, based on the first internet protocol address, data content of the data to be requested.

2. The method according to claim 1, further comprising:
receiving the address description information sent by the business server;
wherein the requesting, based on the first internet protocol address, the data content of the data to be requested comprises:
requesting, based on the first internet protocol address and the address description information, the data content of the data to be requested.

3. The method according to claim 2, wherein the requesting, based on the first internet protocol address and the address description information, the data content of the data to be requested comprises:
establishing a first connection to a content server based on the first internet protocol address, and performing a local domain name resolution on the address description information; and
requesting, from the content server based on an establishment status of the first connection and a resolution status of the local domain name resolution, the data content of the data to be requested.

4. The method according to claim 3, wherein the requesting, from the content server based on the establishment status of the first connection and the resolution status of the local domain name resolution, the data content of the data to be requested comprises:
in response to the establishment status being successful establishment and the resolution status being resolving, requesting the data content from the content server based on the first connection;
in response to the establishment status being establishing and the resolution status being failed resolution, continuing to establish the first connection;
in response to the establishment status being establishing and the resolution status being successful resolution, comparing a second internet protocol address obtained by resolution with the first internet protocol address, and requesting the data content from the content server based on a comparison result; and
in response to the establishment status being failed establishment and the resolution status being resolving, continuing to perform the local domain name resolution.

5. The method according to claim 4, wherein the requesting the data content from the content server based on the comparison result comprises:
in response to the second internet protocol address being a same address as the first internet protocol address, continuing to establish the first connection; and
in response to the second internet protocol address being different from the first internet protocol address, establishing a second connection to the content server based on the second internet protocol address.

6. The method according to claim 2, wherein the requesting, based on the first internet protocol address and the address description information, the data content of the data to be requested comprises:
establishing a first connection to a content server based on the first internet protocol address;
in response to the first connection being not established within a preset time duration, performing local domain name resolution on the address description information; and
requesting, from the content server based on an establishment status of the first connection and a resolution status of the local domain name resolution, the data content of the data to be requested.

7. A data request method, applied to a server, comprising:
receiving a data request sent by a client, and determining, based on the data request, address description information of data to be requested;
performing network-side domain name resolution on the address description information to obtain a first internet protocol address; and
sending the first internet protocol address to the client, so that the client requests, based on the first internet protocol address, data content of the data to be requested.

8. An electronic device, comprising:
one or more processors; and
a storage apparatus configured to store one or more programs, wherein
the one or more programs, when executed by the one or more processors, cause the one or more processors to:
send a data request to a business server, so that the business server determines, based on the data request, address description information of data to be requested;
receive a first internet protocol address sent by the business server, wherein the first internet protocol address is obtained by performing network-side domain name resolution on the address description information by the business server; and
request, based on the first internet protocol address, data content of the data to be requested.

9. The electronic device according to claim 8, wherein the one or more processors are further caused to:
receive the address description information sent by the business server; and
request, based on the first internet protocol address and the address description information, the data content of the data to be requested.

10. The electronic device according to claim 9, wherein the one or more processors are further caused to:
establish a first connection to a content server based on the first internet protocol address, and perform a local domain name resolution on the address description information; and
request, from the content server based on an establishment status of the first connection and a resolution status of the local domain name resolution, the data content of the data to be requested.

11. The electronic device according to claim 10, wherein the one or more processors are further caused to:
in response to the establishment status being successful establishment and the resolution status being resolving, request the data content from the content server based on the first connection;
in response to the establishment status being establishing and the resolution status being failed resolution, continue to establish the first connection;
in response to the establishment status being establishing and the resolution status being successful resolution, compare a second internet protocol address obtained by resolution with the first internet protocol address, and request the data content from the content server based on a comparison result; and
in response to the establishment status being failed establishment and the resolution status being resolving, continue to perform the local domain name resolution.

12. The electronic device according to claim 11, wherein the one or more processors are further caused to:
in response to the second internet protocol address being a same address as the first internet protocol address, continue to establish the first connection; and
in response to the second internet protocol address being different from the first internet protocol address, establish a second connection to the content server based on the second internet protocol address.

13. The electronic device according to claim 9, wherein the one or more processors are further caused to:
establish a first connection to a content server based on the first internet protocol address;
in response to the first connection being not established within a preset time duration, perform a local domain name resolution on the address description information; and
request, from the content server based on an establishment status of the first connection and a resolution status of the local domain name resolution, the data content of the data to be requested.

14. An electronic device, comprising:
one or more processors; and
a storage apparatus configured to store one or more programs, wherein
the one or more programs, when executed by the one or more processors, cause the one or more processors to implement the data request method according to claim 7.

15. A storage medium comprising computer-executable instructions, wherein the computer-executable instructions, when executed by a computer processor, are used to perform the data request method according to claim 1.

16. The storage medium according to claim 15, wherein the one or more processors are further caused to:
receive the address description information sent by the business server; and
request, based on the first internet protocol address and the address description information, the data content of the data to be requested.

17. The storage medium according to claim 16, wherein the one or more processors are further caused to:
establish a first connection to a content server based on the first internet protocol address, and perform a local domain name resolution on the address description information; and
request, from the content server based on an establishment status of the first connection and a resolution status of the local domain name resolution, the data content of the data to be requested.

18. The storage medium according to claim 17, wherein the one or more processors are further caused to:
in response to the establishment status being successful establishment and the resolution status being resolving, request the data content from the content server based on the first connection;
in response to the establishment status being establishing and the resolution status being failed resolution, continue to establish the first connection;
in response to the establishment status being establishing and the resolution status being successful resolution, compare a second internet protocol address obtained by resolution with the first internet protocol address, and request the data content from the content server based on a comparison result; and
in response to the establishment status being failed establishment and the resolution status being resolving, continue to perform the local domain name resolution.

19. The storage medium according to claim 18, wherein the one or more processors are further caused to:
in response to the second internet protocol address being a same address as the first internet protocol address, continue to establish the first connection; and
in response to the second internet protocol address being different from the first internet protocol address, establish a second connection to the content server based on the second internet protocol address.

20. A storage medium comprising computer-executable instructions, wherein the computer-executable instructions, when executed by a computer processor, are used to perform the data request method according to claim 7.
